(19) United States
(12) Patent Application Publication
(10) Pub. No.: US 2022/0398949 A1
(43) Pub. Date: Dec. 15, 2022

(54) LUMINOUS AND AUTONOMOUS ADVERTISING CASING

(71) Applicant: Lumenco, Cailloux-sur-Fontaines (FR)

(72) Inventor: Julien SITRUK, Saint-Cyr-au-Mont-D'or (FR)

(73) Assignee: Lumenco, Cailloux-sur-Fontaines (FR)

(21) Appl. No.: 17/775,612

(22) PCT Filed: Sep. 29, 2020
(86) PCT No.: PCT/FR2020/051700

§ 371 Date: May 10, 2022

(30) Foreign Application Priority Data
Dec. 4, 2019 (FR) 1913767

(51) Int. Cl. G09F 13/04; G09F 13/08; G09F 27/00; G09F 13/22

(52) U.S. Cl. CPC G09F 13/0409; G09F 13/08; G09F 27/007; G09F 13/22; G09F 2013/222

(57) ABSTRACT

Disclosed is an advertising casing (1) comprising a bottom wall (2), side walls (3) and a front face (4) having an opening (5), the advertising casing (1) comprising:
a light source (7) positioned inside the casing (1);
a diffusion plate (10) for diffusing the light, comprising a decorative layer and closing the opening (5) of the front face (4) of the casing (1).

According to the invention, the light source (7) is electrically connected to a control module (8), the control module (8) is electrically connected to a solar panel (6) positioned on one of the faces of the casing (1) and to a battery (9).

### TECHNICAL FIELD

The invention relates to the field of advertising display and relates to a luminous and autonomous advertising casing.

### PRIOR ART

There is known from the prior art, an advertising casing comprising a bottom wall, side walls and a front face having an opening, the advertising casing comprising:
a light source positioned inside the casing and electrically connected to the power supply network;
a light diffusion plate comprising a decorative layer and closing the opening of the front face of the casing.

The installation of this type of advertising casing is constraining, in particular concerning the installation and connection of the electrical cables supplying the light source. Moreover, another disadvantage inherent to the solution of the prior art resides in the energy consumption of the advertising casing, which can be greatly reduced.

### DISCLOSURE OF THE INVENTION

One of the aims of the invention is therefore to overcome the disadvantages of the prior art by providing a luminous advertising casing, of which the installation is facilitated and of which the energy consumption is reduced.

To this end, an advertising casing has been developed according to the state of the art in that it comprises a bottom wall, side walls and a front face having an opening. The advertising casing further comprises:
a light source positioned inside the casing;
a light diffusion plate comprising a decorative layer and closing the opening of the front face of the casing.

According to the invention, the light source is electrically connected to a control module, the control module is electrically connected to a solar panel positioned on one of the faces of the casing and to a battery.

In this manner, the luminous advertising casing is autonomous. Solar energy captured by the solar panel is stored in the battery during the day and distributed to the light source at night. The energy consumed is greatly reduced and produced directly by the casing itself.

Moreover, the light source is not powered by the power supply network. The external cabling is thus removed, which very clearly facilitates the installation of the advertising casing.

According to one particular embodiment, the light source is fixed on the bottom of the casing and, in order to further decrease the electrical consumption of the advertising casing, the light source comprises light-emitting diodes.

Preferably, and in order to simplify the design of the casing according to the invention, the decorative layer is printed on the light diffusion plate, which is, for example, made of plastic, such as polyvinyl chloride, polycarbonate or any material suitable for diffusing the light from the light source.

Preferably, the control module is electrically connected to a switch positioned on one of the faces of the casing, making it possible to turn the light source on or off as needed.

According to one particular embodiment, the solar panel is positioned on the front face. For example, the solar panel is fixed on an inner face of the front face and is visible through a window arranged in the front face.

In this configuration, the battery and/or the control module are housed inside the casing, under the solar panel.

### BRIEF DESCRIPTION OF THE DRAWINGS

Other characteristics and advantages of the invention will become apparent from the following description, which is given by way of non-limiting indication and made with reference to the appended figures, in which:

FIG. 1 is a schematic perspective view of a preferred embodiment of the advertising casing according to the invention.

### DETAILED DESCRIPTION OF THE INVENTION

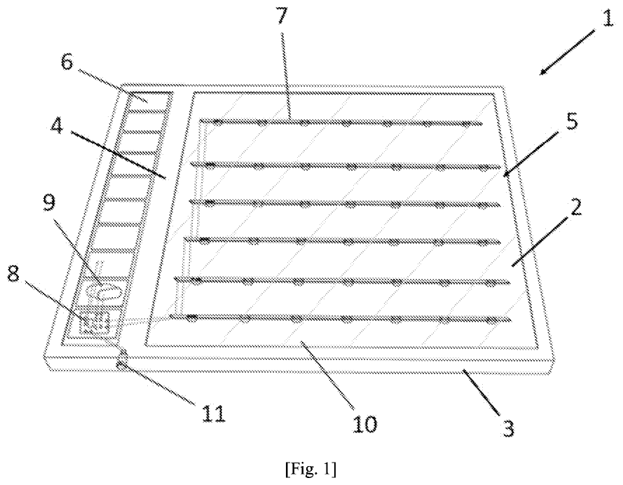

With reference to FIG. 1, the present invention relates to a luminous and autonomous advertising casing (1).

The casing (1) is, for example, of square or parallelepiped shape or any other shape and comprises at least one bottom wall (2), side walls (3) and a front face (4) having an opening (5).

The opening (5) is, for example, square, parallelepipedal or of any other shape, and is formed on the front face (4), leaving a free side strip for positioning a solar panel (6).

The solar panel (6) is for, example, fixed on an inner face of the front face (4) and is visible through a window arranged in the front face (4). The solar panel (6) is fixed by any suitable technique, such as gluing or screwing.

A light source (7), for example, light-emitting diodes, is/are fixed to the bottom wall (2) of the casing (1) by gluing, screwing or any other suitable technique.

These light-emitting diodes are electrically connected, in particular by an electric wire, to a control module (8) housed inside the casing (1) and, for example, fixed and positioned under the solar panel (6).

The control module (8) is electrically connected, in particular by two electric wires, to the solar panel (6) and to a battery (9).

The battery (9) is, for example, housed inside the casing (1) and, for example, fixed and positioned under the solar panel (6).

The advertising casing (1) further comprises a diffusion plate (10) for diffusing the light, comprising a decorative layer and closing the opening (5) of the front face (4) of the casing (1).

The decorative layer is advertising and is, for example, printed on the light-diffusing plate (10), which is, for example, made of plastic, such as polyvinyl chloride, polycarbonate or any material suitable for diffusing the light from the light source (7). The decorative layer can be of any other suitable type, such as, for example, in the form of an adhesive film bonded to the diffusion plate (10). According to another solution, the diffusion plate (10) can itself constitute the decoration directly by being, for example, dyed in the mass.

In this manner, the luminous advertising casing (1) is autonomous. Solar energy captured by the solar panel (6) is stored in the battery (9) during the day and distributed, at night, to the light source (7). The energy consumed is greatly reduced and produced directly by the casing (1) itself.

Moreover, the light source (7) is not powered by the power supply network. The external cabling is thus removed, which greatly facilitates the installation of the advertising casing (1).

The control module (8) manages the transition from night mode, in which it distributes the energy from the battery (9) to the light source (7), to day mode, in which it cuts off the power supply to the light source (7) and sends the energy captured by the solar panel (6) to the battery (9).

The change from night mode to day mode is done by any suitable technique, such as, for example, by a light sensor, by a clock, or by detection that the solar panel (6) sends it a small amount of energy.

The control module (8) is, for example, electrically connected to a switch (11) positioned on one of the faces of the casing (1) making it possible to turn the light source (7) on or off as needed, or to switch the casing (1) into day or night mode.

It is clear from the above that the invention does indeed provide an autonomous, luminous advertising casing (1), the installation of which is facilitated and the energy consumption of which is reduced.

1. Advertising casing (1) comprising a bottom wall (2), side walls (3) and a front face (4) having an opening (5), the advertising casing (1) comprising:
a light source (7) positioned inside the casing (1);
a diffusion plate (10) for diffusing the light, comprising a decorative layer and closing the opening (5) of the front face (4) of the casing (1);
characterised in that the light source (7) is electrically connected to a control module (8), the control module (8) is electrically connected to a solar panel (6) positioned on one of the faces of the casing (1) and to a battery (9).

2. Advertising casing (1) according to claim 1, characterised in that the light source (7) comprises light-emitting diodes.

3. Advertising casing (1) according to claim 1, characterised in that the decorative layer is printed on the light diffusion plate (10).

4. Advertising casing (1) according to claim 1, characterised in that the light diffusion plate (10) is made of plastic.

5. Advertising casing (1) according to claim 1, characterised in that the control module (8) is electrically connected to a switch (11) positioned on one of the faces of the casing (1).

6. Advertising casing (1) according to claim 1, characterised in that the solar panel (6) is positioned on the front face (4).

7. Advertising casing (1) according to claim 6, characterised in that the solar panel (6) is fixed on an inner face of the front face (4) and is visible through a window arranged in the front face (4).

8. Advertising casing (1) according to claim 6, characterised in that the control module (8) is housed inside the casing (1), under the solar panel (6).

9. Advertising casing (1) according to claim 6, characterised in that the battery (9) is housed inside the casing (1), under the solar panel (6).

10. Advertising casing (1) according to claim 1, characterised in that the light source (7) is fixed on the bottom of the casing (1).
